(19) United States
(12) Patent Application Publication
(10) Pub. No.: US 2011/0273340 A1
(43) Pub. Date: Nov. 10, 2011

(54) ANTENNA DEVICE FOR MOBILE TERMINAL

(75) Inventors: Jong Hyeok JEON, Seoul (KR); Seon Kyeng KIM, Yongin-si (KR); Jung Min YANG, Seongnam-si (KR)

(73) Assignee: SAMSUNG ELECTRONICS CO. LTD., Suwon-si (KR)

(21) Appl. No.: 13/099,710

(22) Filed: May 3, 2011

(30) Foreign Application Priority Data
May 6, 2010 (KR) 10-2010-0042543

(51) Int. Cl. H01Q 1/24; H01Q 21/00

(52) U.S. Cl. 343/702; 343/893

(57) ABSTRACT

An antenna device for a mobile terminal is provided. The antenna device is adapted for digital broadcast reception. The mobile terminal is composed of a front case, a rear case, a battery cover, a main board and a feed supplying power on the main board. The mobile terminal includes a first antenna, electrically connected to the feed, for receiving electric current from the feed to receive a digital broadcast signal, and a second antenna, electrically connected to the feed and installed separately from the first antenna, for receiving electric current from the feed to receive a digital broadcast signal. The first antenna and the second antenna are used for antenna matching and bandwidth maintenance during digital broadcast reception. Hence, reception performance of digital broadcast signals can be improved.

### PRIORITY

This application claims the benefit under 35 U.S.C. §119(a) of a Korean patent application filed on May 6, 2010 in the Korean Intellectual Property Office and assigned Serial No. 10-2010-0042543, the entire disclosure of which is hereby incorporated by reference.

### BACKGROUND OF THE INVENTION

1. Field of the Invention

The present invention relates to an antenna device for a mobile terminal More particularly, the present invention relates to an antenna device for digital broadcast reception.

2. Description of the Related Art

Mobile terminals capable of digital broadcast reception can receive and display various digital broadcast signals. In digital broadcasting, a digitally modulated signal carrying multimedia data such as video and text is broadcast to a mobile terminal and the user can view a received digital broadcast displayed on the screen. Currently, different digital broadcasting systems including Digital Multimedia Broadcasting (DMB) and Digital Video Broadcasting (DVB) are used. DMB systems may be classified into Terrestrial DMB (T-DMB) and Satellite DMB (S-DMB) services.

T-DMB uses frequency bands of 180-186 MHz and 204-210 MHz, which are lower than frequencies used for voice and data communication. In general, a length of an antenna is proportional to a wavelength of an intended wave of a frequency band. Hence, a long antenna is to be used to receive a T-DMB signal of a relatively low frequency. Currently, retractable antennas, whose length may be extended and contracted, and removable external antennas are used for mobile terminals capable of T-DMB reception.

In the case of a mobile terminal employing an external antenna, when a user fails to carry the external antenna, the user may experience difficulty in viewing T-DMB broadcasts in a region where the electric field for T-DMB signals is weak.

Additionally, in the case of a mobile terminal whose body contains a large amount of metallic materials, maximum lengthening of a retractable antenna of the mobile terminal or attachment of an external antenna thereto may not be sufficient for smooth reception of a T-DMB signal. Hence, a method that enhances reception performance for digital broadcast signals including a T-DMB signal is needed.

### SUMMARY OF THE INVENTION

Aspects of the present invention are to address at least the above-mentioned problems and/or disadvantages and to provide at least the advantages described below. Accordingly, an aspect of the present invention is to provide an antenna device that enables a mobile terminal to enhance performance in receiving digital broadcast signals.

In accordance with an aspect of the present invention, a mobile terminal composed of a front case, a rear case, a battery cover, a main board and a feed supplying power on the main board is provided. The mobile terminal includes, a first antenna, electrically connected to the feed, for receiving electric current from the feed to receive a digital broadcast signal, and a second antenna, electrically connected to the feed and installed separately from the first antenna, for receiving electric current from the feed to receive a digital broadcast signal, wherein the first antenna and the second antenna are used for antenna matching and bandwidth maintenance during digital broadcast reception.

According to an aspect of the present invention, a mobile terminal may enhance performance in receiving digital broadcast signals. More particularly, since main and auxiliary antennas may be used together in antenna matching and bandwidth maintenance, reception performance of digital broadcast signals can be improved.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates an antenna configuration in a mobile terminal according to an exemplary embodiment of the present invention;

FIG. 2 illustrates another antenna configuration in a mobile terminal according to an exemplary embodiment of the present invention;

FIG. 3 shows an external appearance of a mobile terminal according to an exemplary embodiment of the present invention;

FIGS. 4A and 4B illustrate placement of a second antenna in a front case of a mobile terminal according to an exemplary embodiment of the present invention;

FIGS. 5A and 5B illustrate placement of a second antenna in a rear case of a mobile terminal according to an exemplary embodiment of the present invention;

FIGS. 6A to 6C illustrate placement of a second antenna in the battery cover of a mobile terminal according to an exemplary embodiment of the present invention; and

FIGS. 7A and 7B are charts plotting experimental data to compare passive performance of a mobile terminal according to an exemplary embodiment of the present invention with that of a related art mobile terminal.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the literal bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The description of aspects of the present invention is focused on a mobile communication terminal capable of transmitting and receiving calls and data. However, aspects of the present invention are not limited thereto and they may be applied to any mobile terminal capable of digital broadcast reception, such as a Personal Digital Assistant (PDA), a smart phone, a navigation aid, an International Mobile Telecommunication 2000 (IMT-2000) terminal, a Code Division Multiple Access (CDMA) terminal, a Wideband CDMA (WCDMA) terminal, a Global System for Mobile Communications (GSM) terminal, a General Packet Radio Services (GPRS) terminal, an Enhanced Data Rates for GSM Evolution (EDGE) terminal, a Universal Mobile Telecommunications System (UMTS) terminal, a digital broadcast receiver, or other similar terminals and devices.

The below description is focused on a bar-type mobile terminal. However, aspects of the present invention are not limited thereto and the features discussed below may be applied to any type of mobile terminal capable of digital broadcast reception, such as a bar-type, a slide-type, a folder-type, a swivel-type, or other types of a mobile terminal.

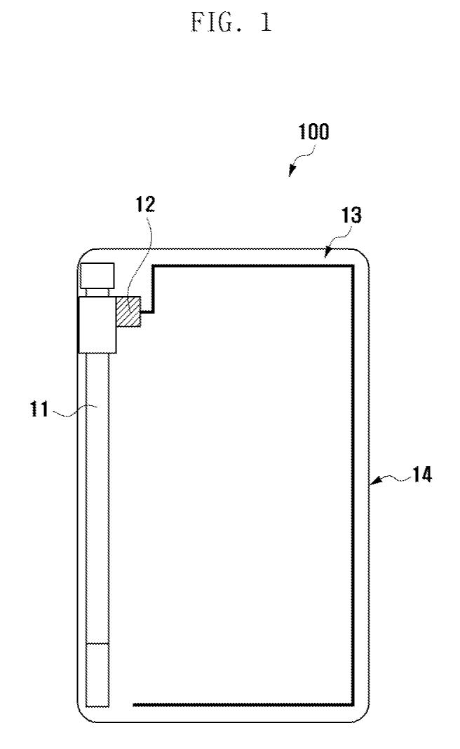

FIG. 1 illustrates an antenna configuration in a mobile terminal according to an exemplary embodiment of the present invention.

Referring to FIG. 1, the mobile terminal 100 includes a first antenna 11, a feed 12, a second antenna 13, and a case 14.

The first antenna 11 acts as a main antenna for receiving a digital broadcast signal. The first antenna 11 includes a receiving part that forms a specific pattern for signal reception according to an electromotive force induced by a radio wave. The first antenna 11 further includes a radiating part that induces an electromotive force to radiate a radio wave. The first antenna 11 is electrically connected to the feed 12 through a connection element and receives electric current from the feed 12. The first antenna 11 may be composed of a retractable antenna whose length may be extended or contracted or an external antenna that may be installed in the mobile terminal 100 and removed therefrom. The first antenna 11 may be a monopole antenna. The first antenna 11 may also be composed of an internal antenna arranged inside the mobile terminal 100. However, aspects of the present invention are not limited thereto, and the first antenna 11 may be of other suitable types of antennas. In the following description, the first antenna 11 is assumed to be a retractable antenna.

The feed 12 supplies electric current to the first antenna 11 and the second antenna 13 as described later. In an exemplary embodiment of the present invention, the feed 12 is formed on a main board (such as a Printed Circuit Board (PCB)) of the mobile terminal 100. The feed 12 includes a signal forwarder that transfers a digital broadcast signal received by the first antenna 11 or the second antenna 13 to the main board. Also, a ground point electrically connected to a ground stub may reside close to the feed 12.

The second antenna 13 is connected to the feed 12, and receives electric current from the feed 12 to receive the digital broadcast signal. The second antenna 13 receives the digital broadcast signal and acts as an auxiliary antenna assisting the first antenna 11 in the receiving of the digital broadcast signal. In an exemplary embodiment, the second antenna 13 is formed in the case 14 in a zone other than a zone where the first antenna 11 is formed within the case 14. That is, the second antenna 13 is arranged so as to be separate from the first antenna 11. In some exemplary embodiments of the present invention, the second antenna 13 may be molded into the case 14 or may be realized using a Flexible Printed Circuit Board (FPCB) within the case 14.

In FIG. 1, the second antenna 13 takes a form of a line placed along a border region of the case 14. The second antenna 13 may be arranged along a part of or the whole of the border region of the case 14. In other words, the second antenna 13 may be arranged in a part of the border region of the case 14 where the first antenna 11 is not formed. When the second antenna 13 is arranged in the border region of the case 14, it may be molded into the case 14 or bonded to the case 14 using an insulating tape. However, aspects of the present invention are not limited thereto, and the second antenna 13 may be fixed to the case 14 using other suitable means. A length of the second antenna 13 may vary according to a size of the case 14 and may be set to a value producing a highest sensitivity for digital broadcast reception. For example, the second antenna 13 may be set to have a length of about 10 cm.

The second antenna 13 is used together with the first antenna 11 for bandwidth acquisition, antenna matching and signal matching. The second antenna 13 receives a digital broadcast signal together with the first antenna 11, and a length and arrangement of the second antenna 13 may be varied according to a length and arrangement of the first antenna 11.

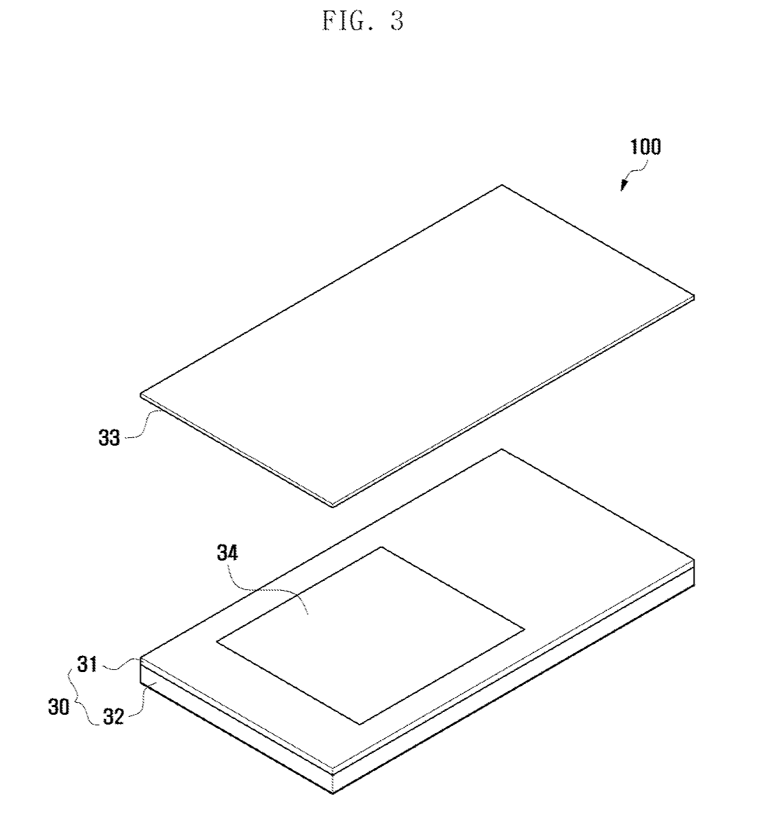

The case 14 is a cover of the mobile terminal 100. The first antenna 11, the feed 12 and the second antenna 13 are located within the case 14. In some exemplary embodiments of the present invention, the case 14 may be composed of a main body 30 and a battery cover 33 (see FIG. 3), and the main body 30 may be composed of a front case 32 and a rear case 31 (see FIG. 3). In the mobile terminal 100, the front case 32 corresponds to a surface on which the display screen is located, and the rear case 31 corresponds to a surface on which the battery is installed. The first antenna 11 and the feed 12 may be formed in the front case 32 or the rear case 31, and the second antenna 13 may be formed in the front case 32, the rear case 31 or the battery cover. However, aspects of the present invention are not limited thereto, and the first antenna 11 and the second antenna 13 may be formed in other suitable manners.

When the feed 12 and the second antenna 13 are formed in the front case, the second antenna 13 may be directly electrically connected to the feed 12. When the feed 12 and the second antenna 13 are respectively formed in the front case 32 and the rear case 31, a connection element (not shown) may be formed to connect the feed 12 and the second antenna 13 in the rear case 31. When the feed 12 and the second antenna 13 are respectively formed in the front case 32 and the battery cover 33, a first connection element may be formed to connect the feed 12 and the second antenna 13 in the battery cover 33, and a second connection element may be formed to connect the first connection element and the feed 12 in the rear case 31.

When the feed 12 and the second antenna 13 are formed in the rear case, the second antenna 13 may be directly electrically connected to the feed 12. When the feed 12 and the second antenna 13 are respectively formed in the rear case and the battery cover, a connection element (not shown) may be formed to connect the feed 12 and the second antenna 13 in the battery cover 33.

In some exemplary embodiments of the present invention, the mobile terminal 100 includes a broadcast signal processing module (not shown) to process a received digital broadcast signal. The broadcast signal processing module processes a digital broadcast signal that has been received by the first antenna 11 and the second antenna 13 and forwarded by the feed 12 thereto.

Although not shown, the mobile terminal 100 may further include a display unit outputting image data of a digital broadcast, an audio processing unit outputting audio data of the digital broadcast, and a control unit sending control signals to the broadcast signal processing module, display unit and the audio processing unit. The broadcast signal processing module and the control unit may be integrated into the main board of the mobile terminal 100.

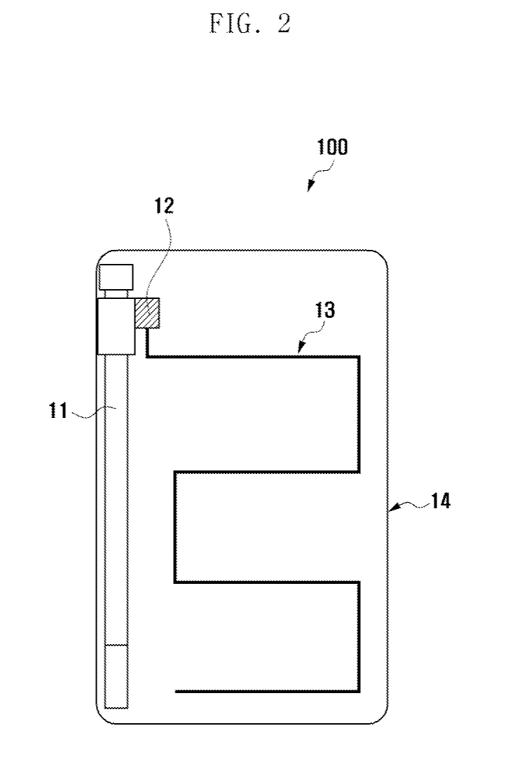

FIG. 2 illustrates another antenna configuration in a mobile terminal according to an exemplary embodiment of the present invention.

As in the exemplary embodiment of FIG. 1, the mobile terminal 100 of FIG. 2 includes a first antenna 11, a feed 12, a second antenna 13, and a case 14. The description given of the first antenna 11, the feed 12 and the case 14 of FIG. 1 is also applicable to the first antenna 11, the feed 12 and the case 14 of FIG. 2.

Referring to FIG. 2, the second antenna 13 is arranged in a specific pattern in the internal region (not the border region) of the case 14. The second antenna 13 may be molded in the front case 32, the rear case 31 or the battery cover 33 or be realized using a Flexible Printed Circuit Board (FPCB). When the main board of the mobile terminal 100 is present in the front case 32 and the second antenna 13 is formed using an FPCB in the front case 31, an insulating material may be disposed between the main board and the second antenna 13. When the second antenna 13 is formed using an FPCB in the rear case 31, it may be attached to the inner surface of the rear case 31. When the second antenna 13 is formed using an FPCB in the battery cover 33, it may be attached to an inner surface of the battery cover 33.

In some exemplary embodiments of the present invention, the second antenna 13 may be formed as a line antenna, a microstrip slot antenna, a microstrip ring antenna, a microstrip patch antenna, a surface mounted antenna or as other suitable antenna types.

Hereinabove, a description is given of the overall antenna configuration of the mobile terminal 100 in connection with FIGS. 1 and 2. Next, a description will be given of the antenna configuration with reference to FIGS. 3 to 6.

FIG. 3 shows an external appearance of a mobile terminal according to an exemplary embodiment of the present invention.

Referring to FIG. 3, the mobile terminal 100 includes a main body 30, a battery cover 33 and a battery 34. In FIG. 3, the mobile terminal 100 shows the display unit face down, and the battery cover 33 is detached from the main body 34. As described before, the main body 30 includes a rear case 31 and a front case 32. The rear case 31 includes a groove in which the battery 34 is installed. Although not shown, the front case 32 includes a region allocated for the display unit. In some exemplary embodiments of the present invention, the first antenna 11 may be formed to be attached to the rear case 31 or the front case 32, and the feed 12 may be formed in the front case 32 or the rear case 31. Next, a description is given of an arrangement of the second antenna 13 under the assumption that the first antenna 11 is attached to the rear case 31 and the feed 12 is formed in the front case 32.

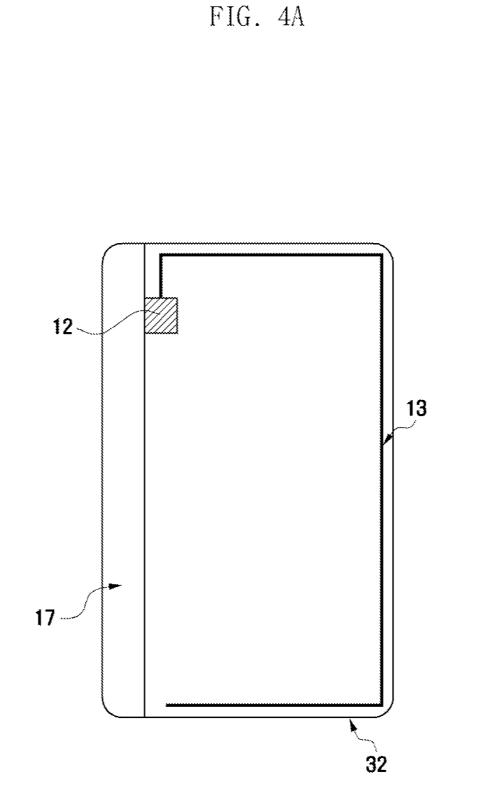

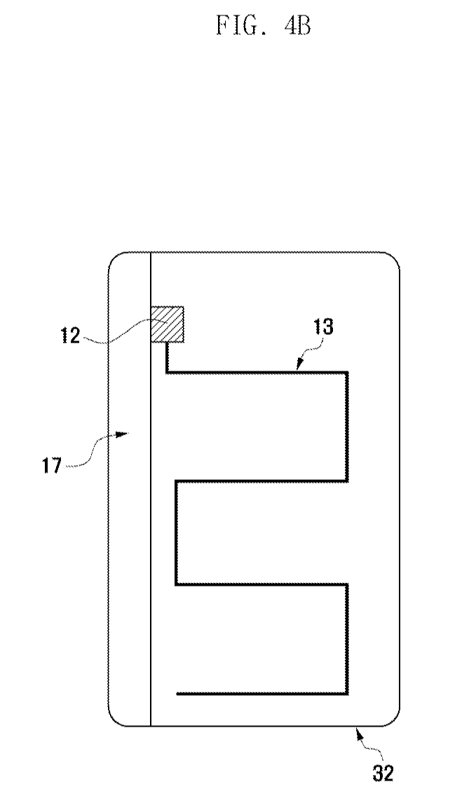

FIGS. 4A and 4B illustrate placement of a second antenna in a front case of a mobile terminal according to an exemplary embodiment of the present invention. In FIGS. 4A and 4B, the inner surface of the front case is depicted.

Referring to FIG. 4A, the front case 32 is depicted as containing a feed 12, a second antenna 13, and a guide hole 17 for the first antenna 11. The feed 12 is placed on the main board (not shown) and supplies electric current to the second antenna 13 and the first antenna 11 inserted in the guide hole 17. The guide hole 17 is a space in which the first antenna 11 is placed and guides extending and contracting of the first antenna 11. The second antenna 13 is connected to the feed 12 and is arranged along the border of the front case 32. According to some exemplary embodiments of the present invention, the second antenna 13 may be formed in the front case 32 through molding along the border of the front case 32. The second antenna 13 may also be attached along the border of the front case 32 using an insulating tape. The second antenna 13 may also be formed as a specific pattern of an FPCB within the front case 32. In this case, an insulating material in the form of a tape may be disposed between the FPCB and the main board. However, aspects of the present invention are not limited thereto, and the second antenna 13 may be formed and attached in other suitable manners.

The feed 12 is connected to the first antenna 11 via a connection element (not shown) of the rear case 31, and is directly electrically connected to the second antenna 13 so as to supply electric current to the first antenna 11 and the second antenna 13. In addition, the feed 12 transfers a digital broadcast signal received by the first antenna 11 and the second antenna 13 to the main board. The broadcast signal processing module connected to the main board processes the received digital broadcast signal and forwards the processed digital broadcast signal to the control unit, which then controls the display unit and the audio processing unit so as to output the processed digital broadcast signal.

Referring to FIG. 4B, the second antenna 13 is arranged in a pattern different from that shown in the embodiment of FIG. 4A. In FIG. 4B, the second antenna 13 is formed in a specific pattern in an internal region of the front case 32. As in the embodiment of FIG. 4A, the second antenna 13 may be molded into the front case 32, be attached to the front case 32 using an insulating tape, or be realized using an FPCB.

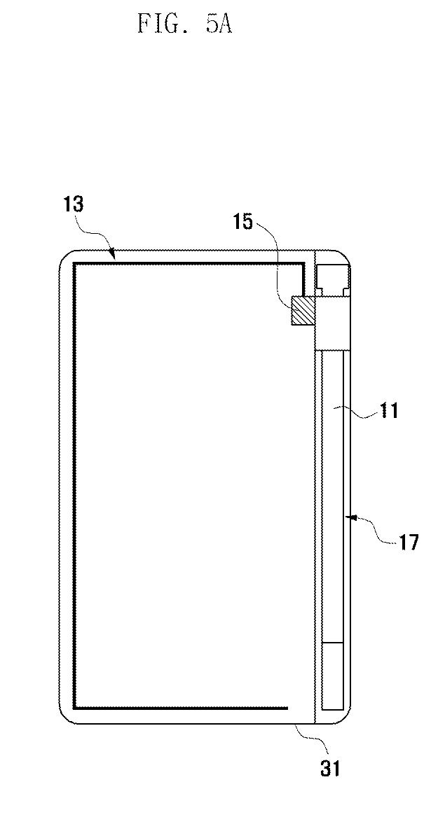

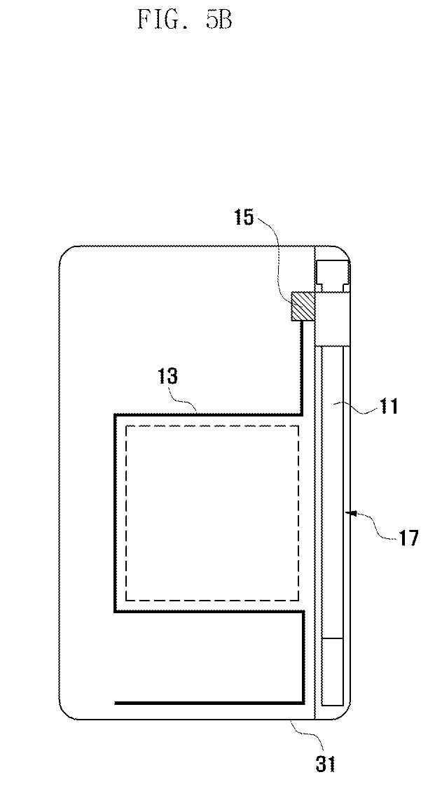

FIGS. 5A and 5B illustrate placement of a second antenna 13 in a rear case of a mobile terminal according to an exemplary embodiment of the present invention. In FIGS. 5A and 5B, the inner surface of the rear case is depicted.

Referring to FIG. 5A, the rear case 31 is depicted as containing a first antenna 11, a second antenna 13, a guide hole 17 for the first antenna 11, and a feed connecting element 15. The feed connecting element 15 is connected to both the first antenna 11 and the second antenna 13. The feed connecting element 15 is formed in an area of the rear case 31 that corresponds to an area of the front case 32 at which the feed 12 is formed when the rear case 31 is assembled with the front case 32 as shown in FIG. 3.

The feed connecting element 15 may be disposed on the inner surface of the rear case 31 or is formed on both the inner surface and the outer surface of the rear case 31. The feed connecting element 15 is electrically connected to the feed 12 when the rear case 31 is assembled with the front case 32. In the mobile terminal 100, when the first antenna 11 is arranged so as to be attached to the front case 32, the first antenna 11 may be directly connected to the feed 12. Also, when the feed 12 is formed in the rear case 31, the first antenna 11 may be directly connected to the feed 12. However, aspects of the present invention are not limited thereto, and the first antenna 11 may be connected to the feed 12 in other suitable manners.

The first antenna 11 and the second antenna 13 receive electric current supplied by the feed 12 via the feed connecting element 15. The guide hole 17 is a space in which the first antenna 11 is placed and guides expanding and contracting of the first antenna 11. The second antenna 13 is connected to the feed connecting element 15 to receive electric current from the feed 12 and is arranged along the border of the rear case 31. According to some exemplary embodiments of the present invention, the second antenna 13 may be formed in the rear case 31 through molding along the border thereof. The second antenna 13 may also be attached along the border of the rear case 31 using an insulating tape. The second antenna 13 may also be formed as a specific pattern of an FPCB within the rear case 31.

Referring to FIG. 5B, the second antenna 13 is arranged in a pattern different from that of the embodiment FIG. 5A. In FIG. 5B, the second antenna 13 is formed in a specific pattern in an internal region of the rear case 31. As in the embodiment of FIG. 5A, the second antenna 13 may be molded into the rear case 31, be attached to the rear case 31 using an insulating tape, or be realized using an FPCB. More particularly, when the rear case 31 includes a groove for battery accommodation, the second antenna 13 may be arranged around the sides of the groove in the rear case 31 as shown in FIG. 5B.

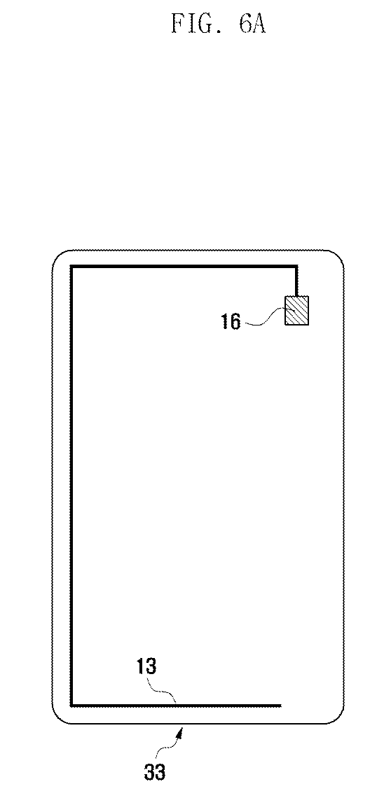

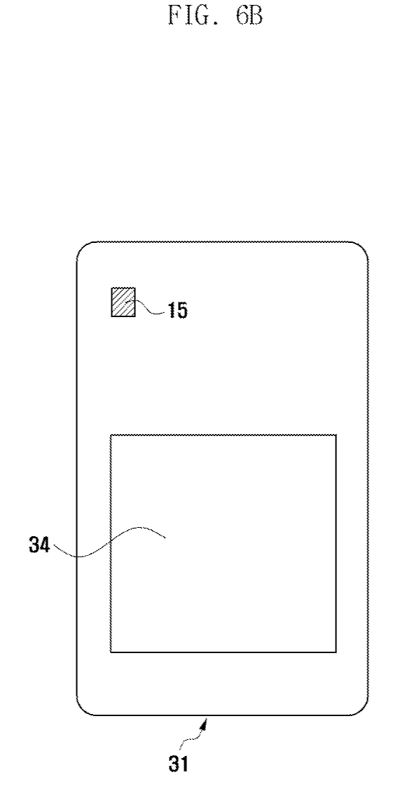

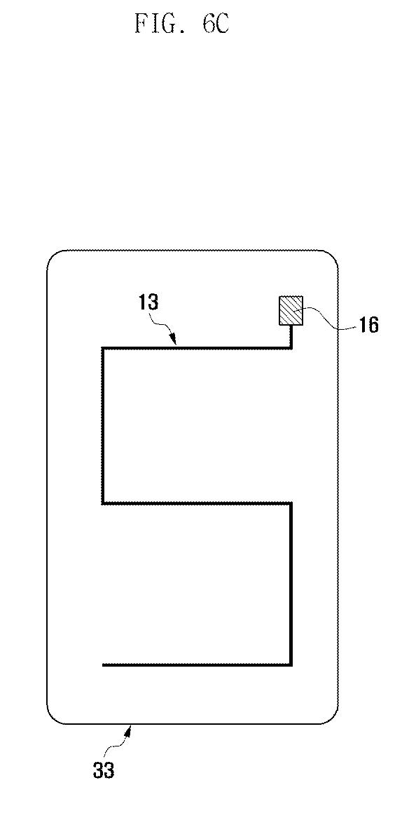

FIGS. 6A to 6C illustrate placement of a second antenna in a battery cover of a mobile terminal according to an exemplary embodiment of the present invention. FIG. 6A illustrates a battery cover 33 including a second antenna 13 and a feed connecting element 16. The feed connecting element 16 is connected to the second antenna 13. FIG. 6B illustrates a rear case 31 including a feed connecting element 15. With reference to FIG. 6A, the feed connecting element 16 is formed at a site of the battery cover 33 that corresponds to a site of the rear case 31 at which the feed connecting element 15 is formed when the battery cover 33 is assembled with the rear case 31, as shown in FIG. 3. When the battery cover 33 is assembled with the rear case 31, the feed connecting element 16 is connected, via the feed connecting element 15 of the rear case 31, to the feed 12 of the front case 32. In the mobile terminal 100, when the feed 12 is formed in the rear case 31, the second antenna 13 may be connected to the feed 12 via the feed connecting element 16 of the battery cover 33 and the feed connecting element 15 of the rear case 31.

The second antenna 13 receives electric current from the feed 12 via the feed connecting element 16 and the feed connecting element 15. The second antenna 13 is arranged along the border of the battery cover 33. According to some exemplary embodiments of the present invention, the second antenna 13 may be formed in the battery cover 33 through molding along the border thereof. The second antenna 13 may also be attached along the border of the battery cover 33 using an insulating tape. The second antenna 13 may also be formed as a specific pattern of an FPCB attached to the inner surface of the battery cover 33.

Referring to FIG. 6C, the second antenna 13 is arranged in a pattern different from that of the embodiments of FIGS. 6A and 6B. In FIG. 6C, the second antenna 13 is formed as a specific pattern in an internal region of the battery cover 33. As in the embodiments of FIGS. 6A and 6B, the second antenna 13 may be molded into the battery cover 33, may be attached to the battery cover 33 using an insulating tape, or may be realized using an FPCB.

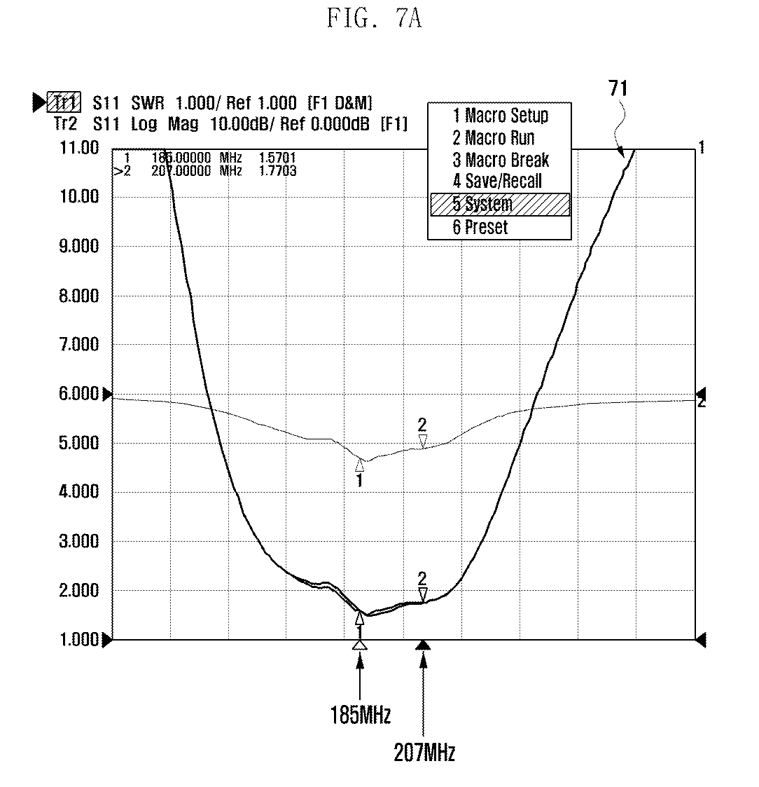

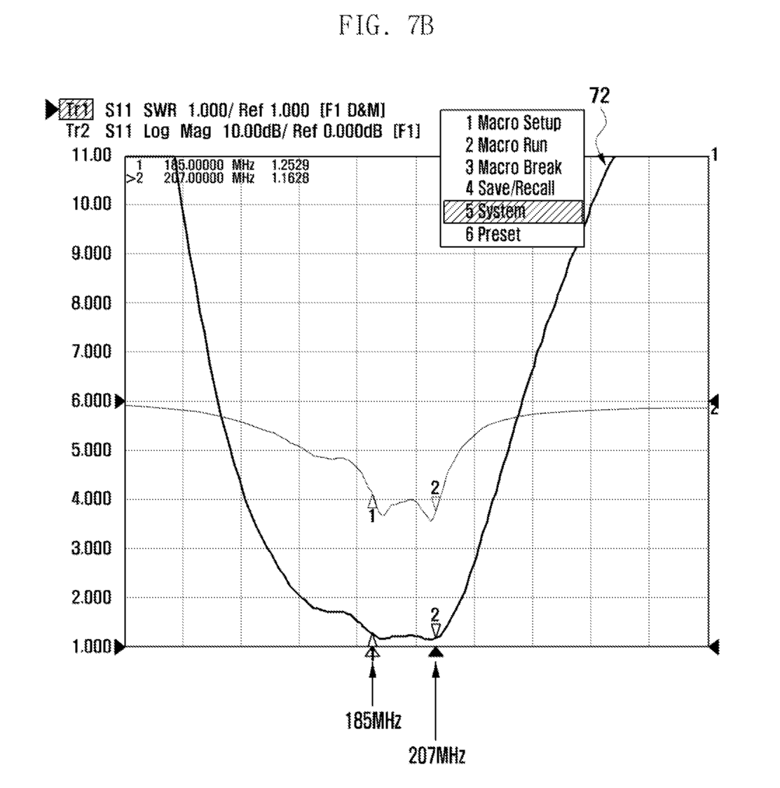

FIGS. 7A and 7B are charts plotting experimental data comparing passive performance of a mobile terminal according to an exemplary embodiment of the present invention with that of a related art mobile terminal. In the experiment, a mobile terminal having one monopole antenna was utilized as the related art mobile terminal and a mobile terminal 100 whose battery cover 33 includes the second antenna 13 (see FIG. 6B) was utilized as the mobile terminal according to aspects of the present invention. To evaluate passive performance, the Voltage Standing Wave Ratio (VSWR) is computed for each mobile terminal. VSWR refers to the ratio of maximum voltage to minimum voltage on a coaxial feed line, and a VSWR of 1 indicates a best matching of voltages. In other words, the closer the VSWR is to 1, the better.

The chart of FIG. 7A plots VSWR with respect to frequency for the related art mobile terminal, and the chart of FIG. 7B plots VSWR with respect to frequency for the exemplary mobile terminal according to aspects of the present invention. For each mobile terminal, Table 1 shows VSWR values at given frequencies.

TABLE 1

| | 185 MHz | 207 MHz |
|---|---|---|
| Related art mobile | 1.57 | 1.77 |
| terminal | | |
| Exemplary Mobile | 1.25 | 1.16 |
| terminal | | |

Referring to FIG. 7A, curve 71 indicates VSWR with respect to frequency and the frequencies at points ‘1’ and ‘2’ are 185 MHz and 207 MHz, respectively, and measured VSWR values at 185 MHz and 207 MHz are 1.57 and 1.77, respectively.

Referring to FIG. 7B, curve 72 indicates VSWR with respect to frequency and the frequencies at points ‘1’ and ‘2’ are 185 MHz and 207 MHz, respectively, and VSWR values measured at 185 MHz and 207 MHz are 1.25 and 1.16, respectively.

As indicated by Table 1, the exemplary mobile terminal according to aspects of the present invention produced VSWR values closer to 1 at desired frequencies than the related art mobile terminal.

In addition, measurement of active performance for the exemplary mobile terminal 100 showed enhancement of signal reception performance. Here, the active performance refers to reception sensitivity (the level of sensitivity in actual reception of a broadcast signal using the antenna installed in a mobile terminal), and the unit of reception sensitivity is dBm. Active performance was measured at the same frequencies as passive performance (185 MHz and 207 MHz). Table 2 lists measurement results.

TABLE 2

| | 185 MHz | 207 MHz |
|---|---|---|
| Related art mobile | −56 dBm | −59 dBm |
| terminal | | |
| Exemplary Mobile | −58 dBm | −61 dBm |
| terminal | | |

As Table 2 indicates, the exemplary mobile terminal according to aspects of the present invention showed reception sensitivity enhancement of −2 dBm in comparison to the related art mobile terminal.

As described above, the exemplary mobile terminal is equipped with a main antenna and an auxiliary antenna that share a feed supplying electric current. Hence, when the main antenna is deactivated or fails in normal operation, the auxiliary antenna may receive broadcast signals instead of the main antenna, preventing degradation of reception sensitivity. Unlike a related art mobile terminal using a single main antenna, which may experience difficulty in antenna matching and bandwidth acquisition, the exemplary mobile terminal according to aspects of the present invention may use the auxiliary antenna as a tuning point for antenna matching and bandwidth acquisition.

Accordingly, the exemplary mobile terminal according to aspects of the present invention provides excellent reception performance not only in a region where the electric field for digital broadcast signals is strong but also in a region where the electric field for digital broadcast signals is weak.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A mobile terminal composed of a front case, a rear case, a battery cover, a main board and a feed supplying power on the main board, the mobile terminal comprising:
a first antenna electrically connected to the feed, for receiving electric current from the feed to receive a digital broadcast signal; and
a second antenna, electrically connected to the feed and installed separately from the first antenna, for receiving electric current from the feed to receive a digital broadcast signal,
wherein the first antenna and the second antenna are used for antenna matching and bandwidth maintenance during digital broadcast reception.

2. The mobile terminal of claim 1, wherein the first antenna corresponds to a main Digital Multimedia Broadcasting (DMB) antenna and the second antenna corresponds to an auxiliary DMB antenna.

3. The mobile terminal of claim 1, wherein the main board is installed within the front case.

4. The mobile terminal of claim 3, wherein the second antenna is arranged around a border of the front case and is directly connected to the feed.

5. The mobile terminal of claim 3, wherein the second antenna is molded into the border in the front case and is directly connected to the feed.

6. The mobile terminal of claim 3, wherein a connection element electrically connected to the feed is formed in the rear case.

7. The mobile terminal of claim 6, wherein the second antenna is arranged around a border of the rear case and is electrically connected to the feed via the connection element of the rear case.

8. The mobile terminal of claim 6, wherein the second antenna is molded into a border of the rear case and is electrically connected to the feed via the connection element of the rear case.

9. The mobile terminal of claim 6, wherein a connection element electrically connected to both the connection element of the rear case and the feed is formed in the battery cover.

10. The mobile terminal of claim 9, wherein the second antenna is arranged around the border in the battery cover and is electrically connected to the feed via the connection element of the battery cover and the connection element of the rear case.

11. The mobile terminal of claim 9, wherein the second antenna is molded into the border in the battery cover or realized in a specific pattern on a flexible printed circuit board and is electrically connected to the feed via the connection element of the battery cover and the connection element of the rear case.

12. The mobile terminal of claim 1, further comprising a broadcast signal processing module for processing digital broadcast signals received by the first antenna and the second antenna.

13. The mobile terminal of claim 3, wherein the second antenna is realized as a specific pattern on a Flexible Printed Circuit Board (FPCB) and is directly connected to the feed.

14. The mobile terminal of claim 6, wherein the second antenna is realized as a specific pattern on a flexible printed circuit board and is electrically connected to the feed via the connection element of the rear case.

15. The mobile terminal of claim 1, wherein the first antenna is extendable and contractible.

16. The mobile terminal of claim 1, wherein the second antenna is formed to have a zigzag shape.

17. The mobile terminal of claim 1, wherein the second antenna is formed in the rear case having a groove for accommodating a battery, and
wherein the second antenna is disposed around sides of the groove of the rear case.

18. The mobile terminal of claim 1, wherein the second antenna is bonded to the front case, the rear case or the battery cover with an insulating material.
